(19) United States
(12) Patent Application Publication
(10) Pub. No.: US 2008/0047145 A1
(43) Pub. Date: Feb. 28, 2008

(54) System Comprising an Electric Razor and at Least One Accessory

(76) Inventors: Daniel Dietzel, Kelkheim (DE); Matthias Wetzel, Schoneck (DE); Norbert Kreutz, Wehrheim (DE); Matthias Matern, Steinbach (DE); Volker Stenger, Hosbach (DE); Jurgen Hoser, Neu-Anspach (DE)

Correspondence Address: FISH & RICHARDSON P.C., P.O BOX 1022, Minneapolis, MN, 55440-1022, US

(21) Appl. No.: 11/568,446

(22) PCT Filed: Mar. 18, 2005
(86) PCT No.: PCT/EP05/02891

§ 371 Date: Feb. 13, 2007

(30) Foreign Application Priority Data
Apr. 28, 2004 (DE) 10 2004 020 954.5

(51) Int. Cl. B26B 19/00; B26B 19/28

(52) U.S. Cl. 30/34.05; 30/45

(57) ABSTRACT

A system having an electric shaving apparatus and at least one accessory adapted to be detachably arranged on the shaving apparatus. The shaving apparatus has a shaving head, which has a short-hair cutting device that has at least one perforated outer cutter and at least one undercutter cooperating with the outer cutter. The accessory has two opposite retaining arms adapted to be locked into place on the shaving apparatus. The accessory is adapted to be placed on the shaving head of the shaving apparatus (1) in such a manner that it projects from the shaving apparatus in the area of its retaining arms, and the retaining arms are adapted to be locked into place on the shaving apparatus using a swiveling motion of the accessory, while the accessory continues to rest against the shaving head.

### TECHNICAL FIELD

This invention relates to a system having an electric shaving apparatus and at least one accessory, and to a method for attaching an accessory to an electric shaving apparatus.

### BACKGROUND

Attaching a guard cap to an electric shaving apparatus in the area of its shaving head in order to protect the shaving system, in particular one or more shaving foils, from damage has been described. The guard cap is removed for shaving, and re-attatched to the shaving apparatus on completion of the shaving operation and cleaning of the shaving apparatus. Also, attaching a spacer comb to the shaving head of a shaving apparatus, enabling the beard hairs to be cut to a defined length, has been described. For example, DE 195 38 730 C2 discloses a dry shaver or a hair clipper, including a long-hair cutting system and a spacer comb associated with the long-hair cutting system. The soccer comb is arranged for displacement in two different directions simultaneously. The spacer comb is secured on the housing of the dry shaver or hair clipper when the long-hair cutting system is displaced into its working position.

On the described shaving apparatuses the guard cap, or the spacer comb, is usually pushed onto the shaving apparatus parallel to the longitudinal axis of the shaving apparatus. This necessitates restrictions with regard to the shape of the shaving head, or the area of the housing adjoining the shaving head. Furthermore, a certain outlay is required for the guidance of the guard cap or the spacer comb while being pushed onto the shaving apparatus, and for securing it on the shaving apparatus.

An accessory is needed that can be reliably fixed to an electric shaving apparatus with little outlay, and that can be easily attached and detached.

One aspect of the system according to the invention is an eletric shaving apparatus and at least one accessory, which can be detachably arranged on the shaving apparatus. The shaving apparatus has a shaving head, which has a short-hair cutting device that has at least one perforated outer cutter, and at least one undercutter cooperating with the outer cutter. The accessory has two opposite retaining arms adapted to be locked into place on the shaving apparatus. The accessory can be placed on the shaving head of the shaving apparatus in such a manner that it projects from the shaving apparatus in the area of its retaining arms. The retaining arms can be locked into place on the shaving apparatus using a swiveling motion of the accessory, while the accessory continues to rest against the shaving head.

Certain embodiments may have one or more of the following advantages. One advantage is that the accessory is mountable on, and demountable from the shaving apparatus in every easy manner, and the accessory is reliably fixed in place upon being mounted. Another advantage is that the related manufacturing effort on the shaving apparatus, as well as on the accessory, is comparatively low.

The reliable fixing of the accessory on the shaving apparatus can be assured by the shaving apparatus, and the accessory having interengaging latching members. In this embodiment, the latching members of the shaving apparatus are constructed as fixed projections, and the latching members of the accessory as registering holes or indentations. Thus, eliminating the need for elaborate and vunerable latching mechanisms using springs, balls, etc.

In some embodiments, the retaining arms of the accessory can be latched on the narrow sides of the shaving apparatus so that the usually radiused front face of the shaving head facilitates the swiveling motion of the accessory. In particular, the retaining arms of the accessory can be latched on the shaving apparatus at a location outside the shaving head. In some embodiments, the retaining arms of the accessory, are elastically yielding, resulting in it being possible to dispense with additional elastic elements for latching the retaining arms on the shaving apparatus. In some embodiments, the retaining arms of the accessory are curved such that their free ends are mutually converging. This enables the shaving apparatus to be embraced by the retaining arms in a positive-engagement relationship.

The accessory can have a cover member for covering, at least partially, the short-hair cutting device of the shaving apparatus. In this arrangement each of the retaining arms of the accessory can be spaced from the cover member by a respective recess defining a curve, for example an oval. Furthermore, the retaining arms of the accessory can be mutually converging, at least in some regions, the greater the distance from the cover member. In this way, it is possible to provide for positive engagement between the accessory and the shaving apparatus parallel to the longitudinal axis of the shaving apparatus. With the accessory in latched condition on the shaving apparatus, it can embrace, in shell-like fashion, the shaving apparatus on one front face formed by the shaving head, on one broad side and on two narrow sides.

In a first embodiment of the systerm, the acessory is constructed as a spacer comb. Here it is an advantage for the cover member of the accessory to be of a closed construction. This enables beard stubble which has collected in the short-hair cutting device to be held back. The accessory can have a displaceable comb member. Thus, it is possible to set the cutting length of a long-hair cutting device of the shaving apparatus.

In a second embodiment of the system, the accessory is constructed as a guard cap for the short-hair cutting device. In this embodiment, it is an advantage for the cover member of the accessory to have slits in order to accelerate the drying of the short-hair cutting device. These slits can also serve to shaves so-called three-day beards, in which case the length of the remaining beard is defined by the relative distance of the bars between the slits to the short-hair cutting device. Furthermore, the accessory can have a switch guard for covering a switch of the shaving apparatus, preventing an unwanted actuation of the switch.

In some embodiments, the system can also be constructed such that it includes several accessories which have different functions and are attachable to the shaving apparatus as required. For example, provision can be made for both the spacer comb and the guard cap. Hence, the possible uses of the shaving apparatus can be extended.

Another aspect of the present invention is a method for attaching an accessory, which has two opposite retaining arms, to an electric shaving apparatus. The shaving apparatus has a shaving head with a short-hair cutting device that has at least one perforated outer cutter, and at least one undercutter cooperating with the outer cutter. The accessory is placed on the shaving head of the shaving apparatus in such a manner that it projects from the shaving apparatus in the area of its retaining arms. The retaining arms are locked into place on the shaving apparatus using a swiveling motion of the accessory while the accessory continues to rest against the shaving head.

The present invention will be explained in more detail in the following with reference to the embodiments illustrated in the accompanying drawing.

### BRIEF DESCRIPTION OF THE DRAWINGS

FIG. 1 is a perspective view of a first embodiment of the system.

FIGS. 2, 3, 4 are various side views of the first embodiment of the system; and

FIG. 5 is a perspective view of a second embodiment of the system.

### DETAILED DESCRIPTION

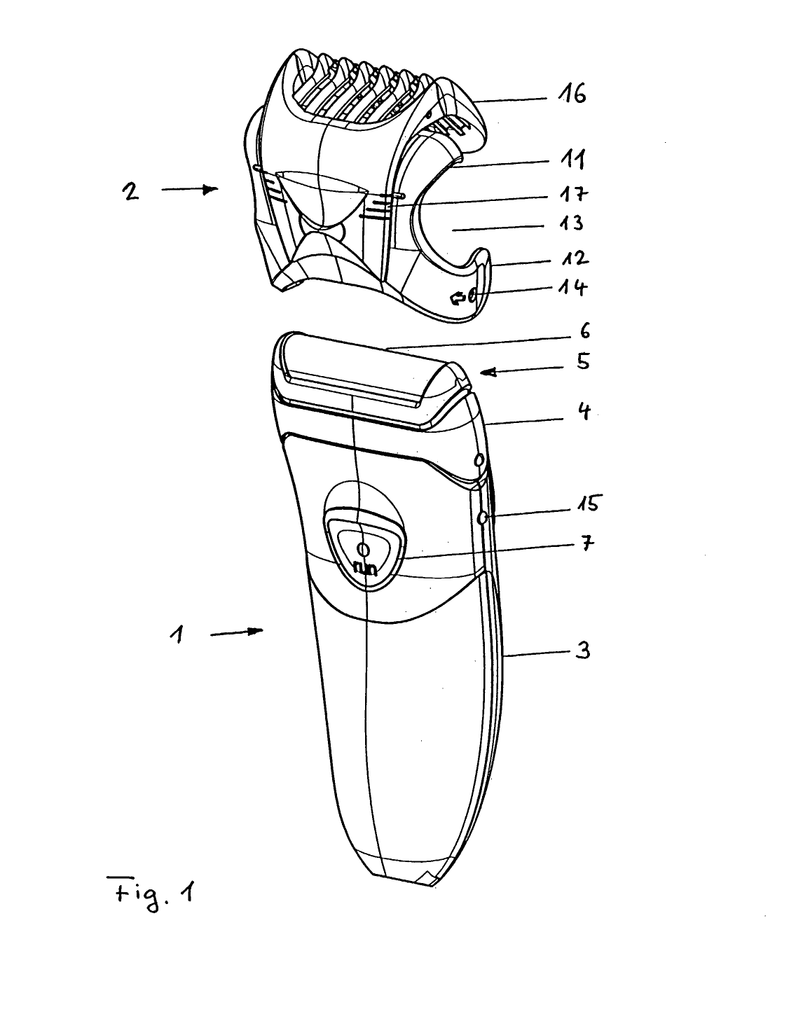

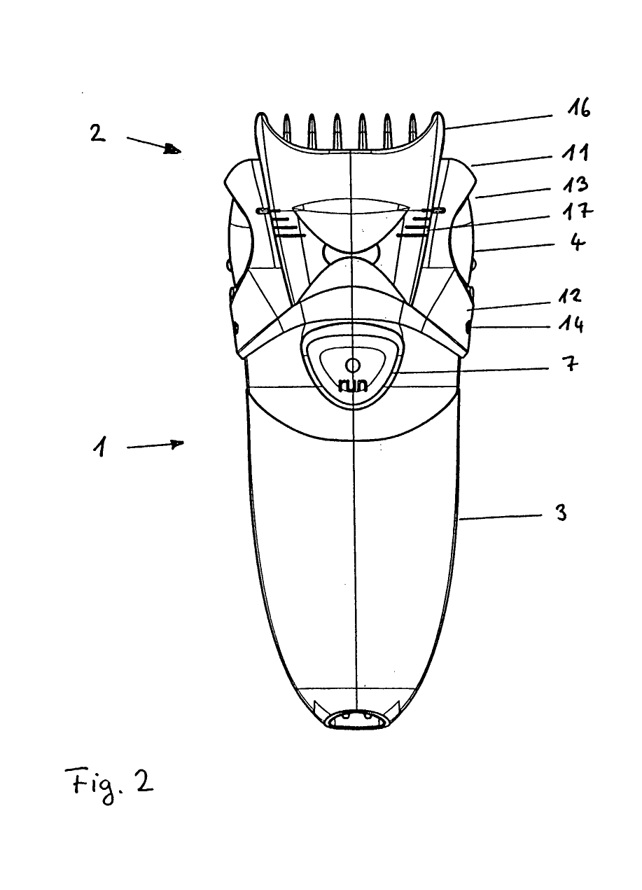

FIG. 1 shows in a perspective representation, a first embodiment of the system. Various side views of the first embodiment are presented in FIGS. 2, 3 and 4. According to the first embodiment, the system has an electric shaving apparatus 1 and a spacer comb 2 constructed as a separate component. In FIG. 1, the spacer comb 2 is shown detached from the shaving apparatus 1. In FIGS. 2, 3 and 4, the spacer comb 2 is presented in each case attached to the shaving apparatus 1.

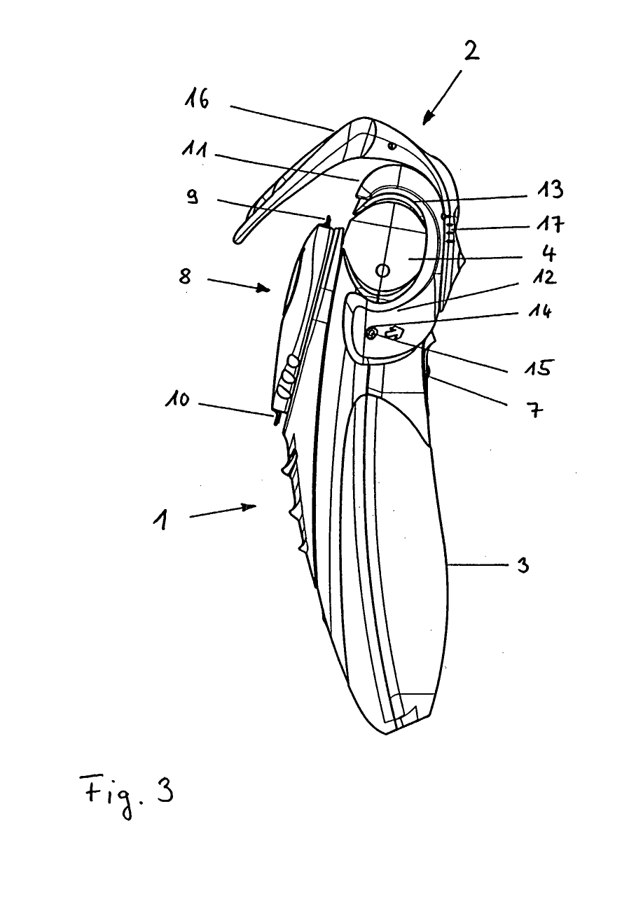

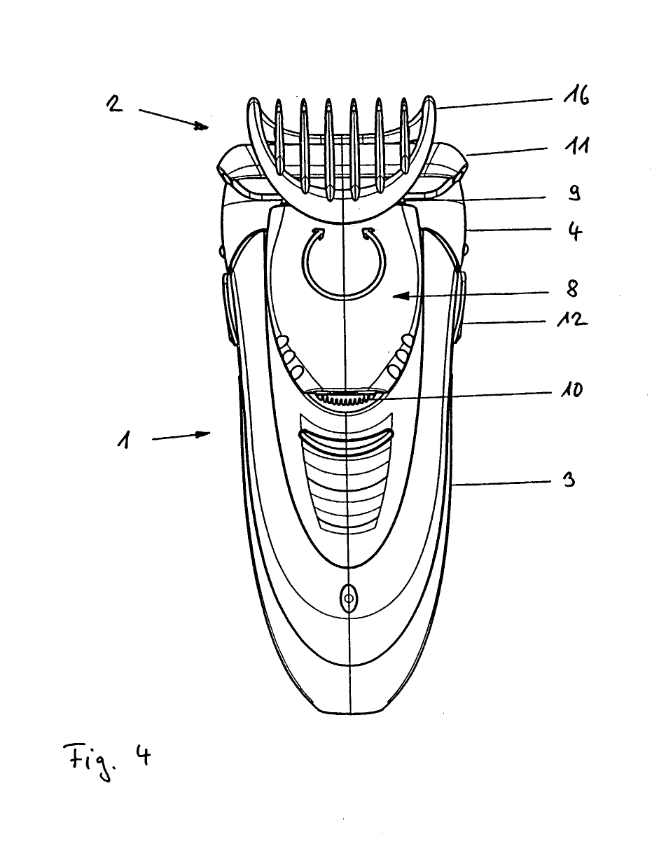

The shaving apparatus 1 has a housing 3 on which a shaving head 4, with a short-hair cutting device 5, is arranged. The short-hair cutting device 5 has a perforated shaving foil 6 and a cutter block, which is covered by the shaving foil 6 and is therefore not visible in the drawing. The short-hair cutting device 5 can be switched on and off by means of a switch 7 which is constructed to be watertight. An electric motor, which is required to operate the short-hair cutting device 5, and its power supply are arranged inside the housing 3 of the shaving apparatus 1, and are therefore are not visible in the drawing. As becomes apparent from FIGS. 3 and 4, the shaving apparatus 1 also has a long-hair cutting device 8, with a first long-hair cutter 9 and a second long-hair cutter 10, which is constructed to be narrower than the first long-hair cutter 9. In some embodiments, the first long-hair cutter 9 or the second long-hair cutter 10 can be swiveled into a standby position and from there be shifted into an operating position.

The spacer comb 2 has a shell-shaped cover member 11, which in the area of the short-hair cutting device 5 rests in some regions against the shaving head 4 of the shaving apparatus 1, when the spacer comb 2 is arranged on the shaving apparatus 1. In this position, the cover member 11 covers the shaving foil 6, and if applicable holds back any beard stubble emerging from the perforations of the shaving foil 6. Formed integrally with the cover member 11 are two inwardly curved retaining arms 12, which are arranged on opposite narrow sides of the spacer comb 2 and, on a broad side of the spacer comb 2, merge into other and into the cover member 11. The retaining arms 12 are each spaced from the cover member 11 by a respective oval recess 13. In combination, the two retaining arms 12 have the cross-sectional shape of a bracket and embrace the housing 3 of the shaving apparatus 1 when the spacer comb 2 is arranged on the shaving apparatus 1. In close proximity to their free ends, the retaining arms 12 each have a hole 14. The holes 14 each serve to receive a respective cylindrical projection 15 on the narrow sides of the shaving apparatus 1. In some embodiments, instead of the holes 14, the retaining arms 12 can also have indentations, extending across only a section of the thickness of the retaining arms 12, to receive the projections 15.

The spacer comb 2 also has a comb member 16 which is displaceable relative to the retaining arms 12. The comb member 16 can be displaced parallel to the longitudinal axis of the shaving apparatus 1 when the spacer comb 2 is arranged on the shaving apparatus 1. Hence, it is possible, in operation of the long-hair cutting device 8, to vary the distance between the comb member 16 and the first long-hair cutter 9 or the second long-hair cutter 10, and with it the cutting length. To enable a reproducible setting of the cutting length, provision is made on the spacer comb 2 for a scale 17 from which the respective displacement of the comb member 16 can be read off.

To attach the spacer comb 2 to the shaving apparatus 1, the spacer comb 2 is moved into engagement with the shaving head 4, in particular with the short-hair cutting device 5, in the area of the cover member 11 such that the spacer comb 2 extends at an acute angle from the broad side of the shaving apparatus 1. Thus, the spacer comb 2 projects in the area of the retaining arms 12 from the shaving apparatus 1. Depending on the size of the angle between the spacer comb 2 and the shaving apparatus 1, the free ends of the retaining arms 12 either touch the housing 3 of the shaving apparatus 1 or are spaced from it. As becomes apparent from FIG. 3, this arrangement is made possible by the comb member 16 being constructed in such a way that it projects at an angle from the spacer comb 2 on one side of the spacer comb 2. Subsequently, the spacer comb 2 is swiveled toward the shaving apparatus 1, while the cover member 11 continues to rest against the shaving head 4. As part of the swiveling motion, the free ends of the retaining armrs 12 slide over the narrow sides of the shaving apparatus 1, and in particular also over the projections 15 constructed there, being expanded elastically in the process.

When the retaining arms 12 have reached their end positions, the holes 14 register with the projections 15. Owing to the elastic bias of the retaining arms 12, the projectons 15 latch in the holes 14 of the retaining arms 12 and fix the spacer comb 2 to the shaving apparatus 1 by positive engagement therewith. Furthermore, the retaining arms 12 partially embrace the shaving apparatus 1, thereby providing for positive emgagement, which prevents the spacer comb 2 from swiveling back. Because the retaining arms 12 of the spacer comb 2, in the region in which they rest against the narrow sides of the shaving apparatus 1, are slightly conically shaped to conform with the outer contour of the housing 3 of the shaving apparatus 1 and because the cover member 11 rests against the shaving head 4, there is also positive engagement between the spacer comb 2 and the shaving apparatus 1 in the longitudinal direction of the shaving apparatus 1 in addition to the engagement of the projections 15 in the holes 14. Hence, the spacer comb 2 is reliably anchored to the shaving apparatus 1 such that the comb member 16 can be displaced into a desired position, and the long-hair cutting device 8 of the shaving apparatus 1 taken into operation.

For detachment of the spacer comb 2 from the shaving apparatus 1, the spacer comb 2 is swiveled away from the shaving apparatus 1 by overcoming the elastic forces acting in the area of the retaining arms 12. At the same time, the spacer comb's cover member 11 continues to rest against the shaving head 4. As a result, the engagement between the projections 15 on the shaving apparatus 1 and the registering holes 14 on the retaining arms 12 is canceled, and the embracement of the shaving apparatus 1 by the retaining arms 12 is released. Subsequently, the spacer comb 2 is removed completely from the shaving apparatus 1, i.e., also in the area of the cover member 11.

In other embodiments of the system, the projections 15 on the shaving apparatus are spring-loaded and caused to retract, at least partly, by the retaining arms 12 when the spacer comb 2 is attached to the shaving apparatus 1. As soon as the end position of the spacer comb 2 is reached, the projections 15 are extended again by the spring action and latch into the holes 14 of the retaining arms 12. In this embodiment, it is not necessary for the spacer comb 2 to be elastically yielding.

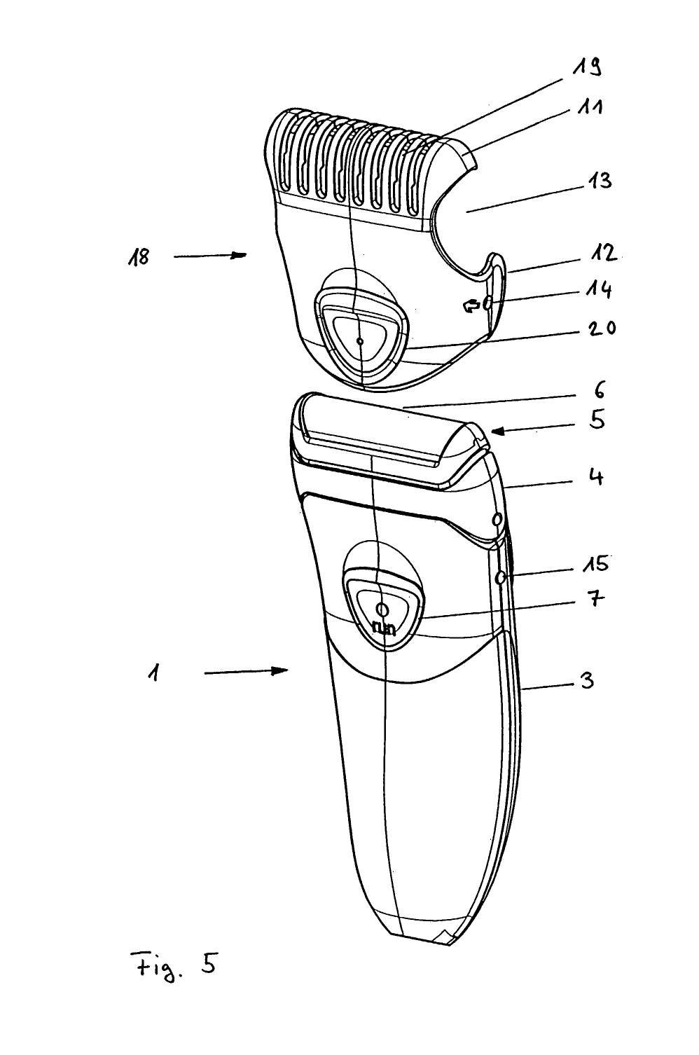

FIG. 5 shows, in a perspective representation, a second embodiment of the system. In the second embodiment, the shaving apparatus 1 is constructed in identical manner to the first embodiment. However, a guard cap 18 instead of the spacer comb 2 is attached to the shaving apparatus 1. The guard cap 18 has a similar basic form to the spacer comb 2 absent the comb member 16. However, unlike the spacer comb 2, the cover member 11 of the guard cap 18 has a series of slits 19. The slits 19 enable the short-hair cutting device 5, which is wetted with a fluid during operation for cleaning purposes, to dry quickly. As another particularity the guard cap 18 has a switch guard 20 which covers the switch 7 of the shaving apparatus 1 when the guard cap 18 is attached to the shaving apparatus 1. An unwanted switching on of the shaving apparatus 1 can thus be prevented with the guard cap 18 attached.

Attaching the guard cap 18 to the shaving apparatus 1 and detaching the guard cap 18 from the shaving apparatus 1 is performed in similar manner to that described for the spacer comb 2.

In further embodiments of the system, provision is made for other accessories instead of the spacer comb 2 or the guard cap 18 to be attachable to the shaving apparatus 1. Similarly it is also possible for the system to be constructed such that provision is made for both the spacer comb 2 and the guard cap 18 and other accessories,if any, to be optionally attachable to the shaving apparatus 1.

Other embodiments are within the scope of the following claims.

1. A system having an electric shaving apparatus and at least one accessory adapted to be detachably arranged on the shaving apparatus, the shaving apparatus having a shaving head comprising a short-hair cutting device that has at least one perforated outer cutter and at least one undercutter cooperating with the outer cutter, and the accessory having two opposite retaining arms adapted to be locked into place on the shaving apparatus, wherein the accessory is adapted to be placed on the shaving head of the shaving apparatus in such a manner that it projects from the shaving apparatus in the area of its retaining arms, and the retaining arms are adapted to be locked into place on the shaving apparatus using a swiveling motion of the accessory, while the accessory continues to rest against the shaving head.

2. The system according to claim 1, wherein the shaving apparatus and the accessory have interengaging latching members.

3. The system according to claim 2, wherein the latching members of the shaving apparatus are constructed as fixed projections, and the latching members of the accessory are registering holes or indentations.

4. The system according to claim 1, wherein the retaining arms of the accessory are adapted to be latched on the narrow sides of the shaving apparatus.

5. The system according to claim 1, wherein the retaining arms of the accessory are adapted to be latched on the shaving apparatus at a location outside the shaving head.

6. The system according to claim 1, wherein the retaining arms of the accessory are elastically yielding.

7. The system according to claim 1, wherein the retaining arms of the accessory are curved such that their free ends are mutaully converging.

8. The system according to claim 1, wherein the accessory has a cover member for covering at least partially, the short-hair cutting device of the shaving apparatus.

9. The system according to claim 8, wherein each of the retaining arms of the accessory is spaced from the cover member by a respective recess defining a curve.

10. The system according to claim 8, wherein the retaining arms of the accessory are mutually converging, at least in some regions, the greater the distance from the cover member.

11. The system according to claim 1, wherein the accessory embraces, in shell-like fashion, the shaving apparatus on one front face formed by the shaving head, on one broad side and on two narrow sides, with the accessory in latched condition on the shaving apparatus.

12. The system according to claim 1, wherein the accessory is constructed as a spacer comb.

13. The system according to claim 12, wherein the cover member of the accessory is of a closed construction.

14. The system according to claim 12, whrein the accessory has a displaceable comb member.

15. The system according to claim 1, wherein the accessory is constructed as a guard cap for the short-hair cutting device.

16. The system according to claim 15, wehrein the cover member of the accessory defines slits.

17. The system according to claim 15, wherein the accessory has a switch guard for covering a switch of the shaving apparatus.

18. The system according to claim 1, further comprising several accessories, which have different functions and are attachable to the shaving apparatus as required.

19. A method for attaching an accessory having two opposite retaining arms, to an electric shaving apparatus comprising a shaving head with a short-hair cutting device that has at least one perforated outer cutter and at least one undercutter cooperating with the outer cutter, the method comprising:
placing the accessory on the shaving head of the shaving apparatus in such a manner that it projects from the shaving apparatus in the area of its retaining arms; and
locking the retaining arms into place on the shaving apparatus using a swiveling motion of the accessory, while the accessory continues to rest against the shaving head.

20. The system according to claim 9, wherein the curve is an oval.
